(19) United States
(12) Patent Application Publication
(10) Pub. No.: US 2015/0371565 A1
(43) Pub. Date: Dec. 24, 2015

(54) Biblok - Race bib protector

(71) Applicant: Emmanuel Jay Marcos Urbano, Beverly Hills, CA (US)

(72) Inventor: Emmanuel Jay Marcos Urbano, Beverly Hills, CA (US)

(21) Appl. No.: 14/742,024

(22) Filed: Jun. 17, 2015

Related U.S. Application Data
(60) Provisional application No. 62/015,181, filed on Jun. 20, 2014.

(51) Int. Cl. G09F 3/20; G09F 21/02; A45F 3/00; A41D 13/00

(52) U.S. Cl. CPC G09F 3/20; A41D 13/0015; G09F 21/02; A45F 3/00; A45F 2003/003

(57) ABSTRACT

The race bib protector (Biblok) is for participants to use during their race event to protect their race bib from getting damaged or dirty. It can be worn on their clothing using safety pins or attached to belts used for holding race bibs. Putting the race bib in the race bib protector helps keep the race bib clean and intact for participants who collect and display them for their own use. It also can hold other items inside such as credit cards and cash, and helps keep the bib flat and visible for others to see.

### CROSS REFERENCE

A provisional patent that was filed on Jun. 20, 2014. EFS ID 19:370874 Application No. 62/015,181

A race bib protector is comprised mostly of a clear ethylene-vinyl acetate plastic with a ziplock seal on one end that opens up to reveal a space to insert a race bib with to keep the race bib and other objects placed inside from falling out and to prevent outside objects from coming into contact with the items that are placed inside. There are two smaller plastic borders at the top and the bottom side of the plastic space that do not open with a hole at each end (corner) that allows the participant to attach it to themselves or attach to other items in order to hold and display their race bib.

### TECHNICAL FIELD The present invention relates to sheet protectors but is used specifically for race bibs and has a ziplock seal to secure the paper(s) and/or object(s) that is placed in it.

### BACKGROUND ART

Race bibs are commonly worn by all participants during a racing event and can get dirty, wet, sticky, and even torn. For those who like to save their bibs, sometimes the bib may be too damaged or dirty to keep after the event.

Normally participants will pin their race bib to their clothing (shirt or shorts/pants), while others wear a bib/fuel belt that only has two fasteners and allows the race bib to hang around their waist area. This can be a problem as the bottom of the race bib isn't securely fastened and can flip upside down and/or flap around due the wind, making the participant's bib number nearly impossible to see.

The participant's clothing may not have a secure pocket to hold items such as their credit card, identification card/license, and even cash, so their option is to either not bring anything with them or to stuff it somewhere in their clothing.

For most race bibs, they have a section on the back of the bib for you to write down your medical information and emergency contact information. If written down in pen or pencil, the information written may fade or be illegible if it gets too wet and/or is rubbed off. The design on the front of the bib may also fade due to water damage or rubbing off.

### Disclosure of Invention

It is according one object of the present invention to provide an easy way for the participant to protect their race bib from getting dirty, wet, or torn.

Another object is that it will help prevent the race bib from flipping upside down or flapping in the wind.

Yet another object is that is allows the participant to store lightweight items such as cash and credit cards.

### BRIEF DESCRIPTION OF THE DRAWINGS

FIG. 1 shows the race bib protector by itself.

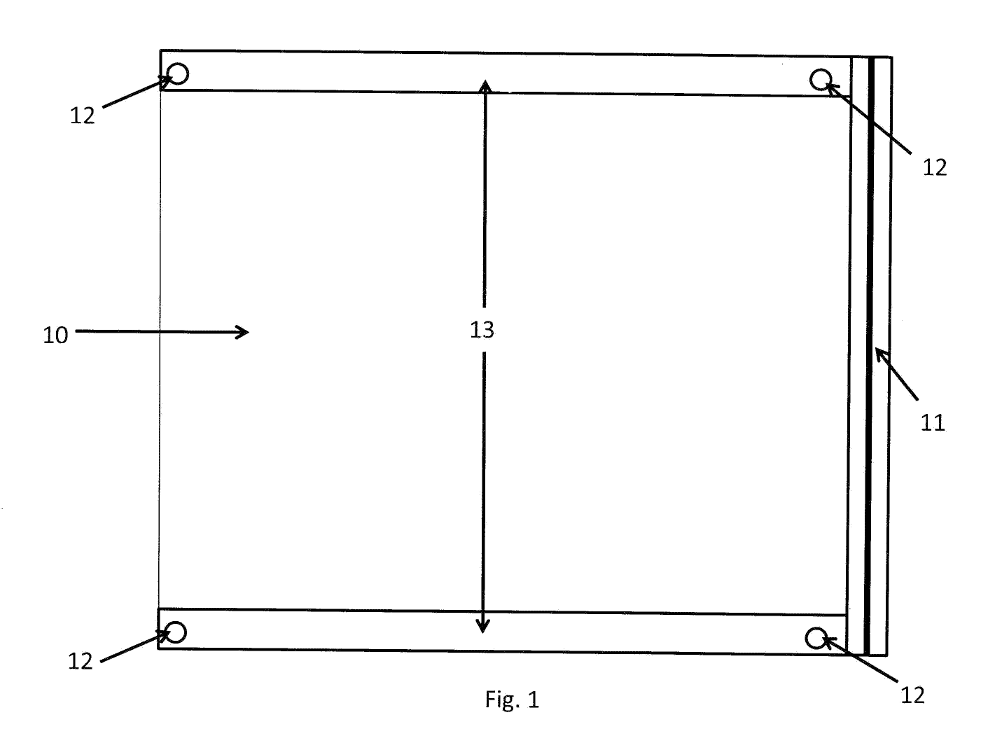

FIG. 2 illustrates what it would look like attached on a participant's shirt using safety pins.

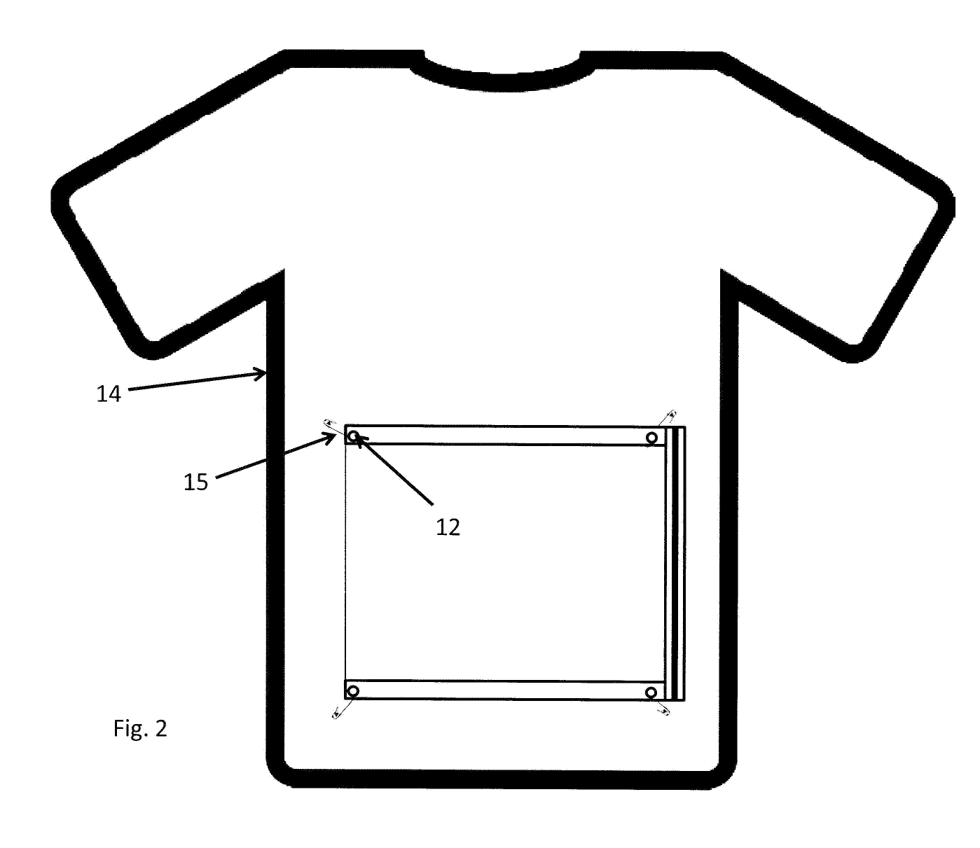

FIG. 3 presents a view of what it would look like when attached to a fuel belt/bib belt

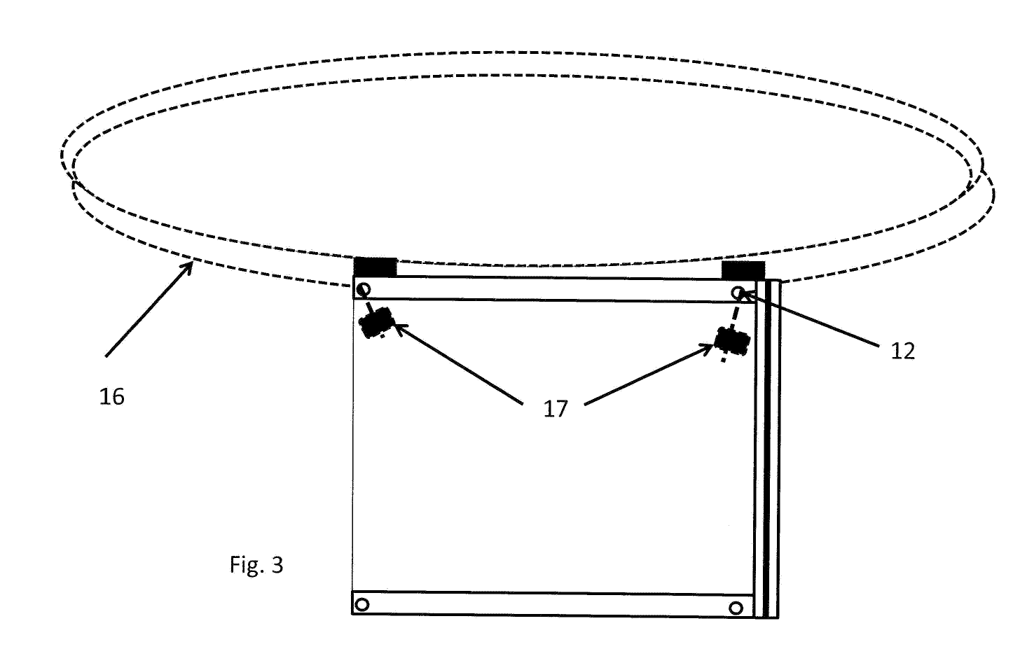

FIG. 4 presents how the race bib is placed in the race bib protector through the ziplock opening on the side

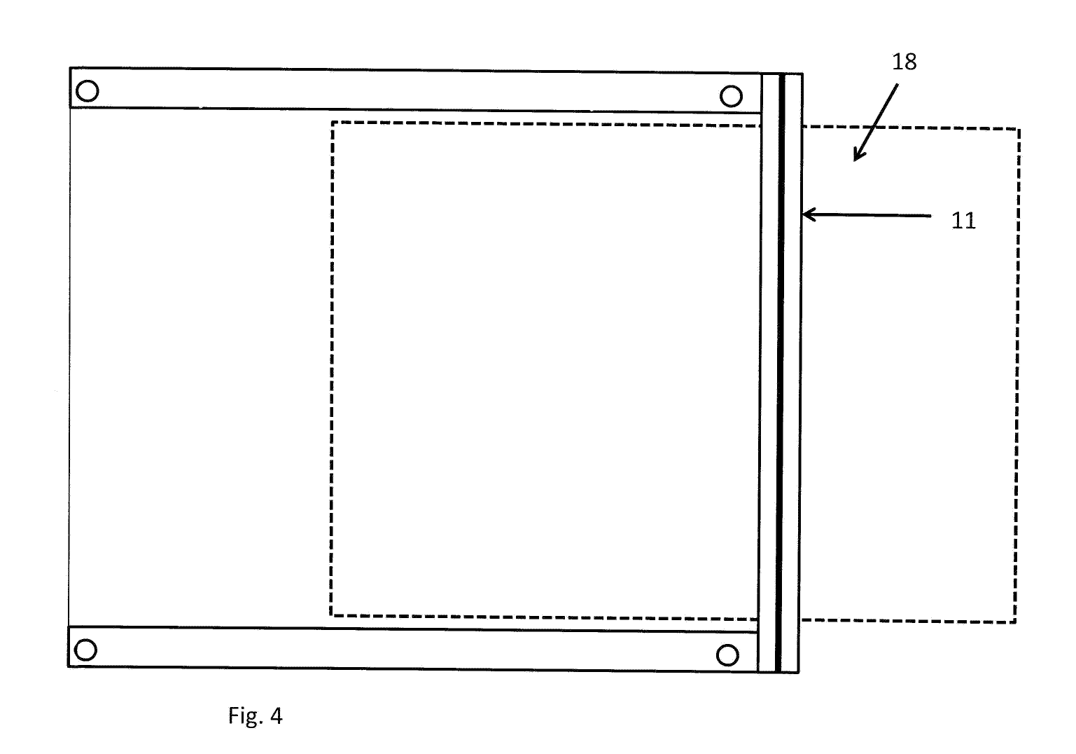

### BEST MODE OF IMPLEMENTATION

The race participant can put their race bib 18 (or any other objects) in this invention by opening ziplock seal 11 and placing it in there to protect the items from getting dirty or wet during a race. The race bib protector is made of ethylene-vinyl acetate and can be secured the participant's t-shirt 14 with safety pins 15 (or other means of securing it to their shirt) through the holes 12 at each corner of the race bib protector located on the two plastic borders 13. If they are using a bib or fuel belt 16, the fasteners 17 can fit through the holes 12 to secure it to the fuel belt 16.

### Brief Summary of The Invention

This invention will help prevent the bib from getting dirty/wet by providing a protective pocket for the runner to put their bib in to help keep it safe and from potential damage while keeping it viewable during their event. This invention also helps the bib keep its shape so that it can be easily seen by other runners, spectators, and race organizers if the 4 corners of the bib are not pinned or secured to the person. If this is used on a bib belt and/or fuel belt, the weight and the shape of the invention will help keep the race bib flat in front of the participant instead of moving to the side, and/or flipping from upside down due to the wind.

I claim:

1. A method of protecting a race bib from getting dirty, sticky, or wet during a race event while keeping the bib visible using mostly a clear athylene-vinyl acetate plastic with a ziplock seal at one end which helps prevent the front design of the race bib and any medical information written on the back of the bib from fading due to friction against the participant's clothing and/or from moisture such as sweat and other liquids.

2. The ziplock seal also provides a secure space to store lightweight items such as cash and cards.

3. The shape and density of the race bib protector helps prevent the race bib from flipping upside down, flapping around, and crumpling by keeping it flat and visible during the race.
